(19) United States
(12) Patent Application Publication
(10) Pub. No.: US 2014/0372945 A1
(43) Pub. Date: Dec. 18, 2014

(54) METHOD FOR OUTPUTTING IMAGES, APPARATUS AND MOBILE TERMINAL THEREFOR

(71) Applicant: BEIJING KINGSOFT INTERNET SECURITY SOFTWARE CO., LTD, Beijing (CN)

(72) Inventors: Ping FAN, Beijing (CN); Ming XU, Beijing (CN)

(21) Appl. No.: 14/304,825

(22) Filed: Jun. 13, 2014

(30) Foreign Application Priority Data
Jun. 17, 2013 (CN) 201310240094.5

(51) Int. Cl. G06F 3/0484; G06F 3/0482; G09G 5/30

(52) U.S. Cl. CPC G06F 3/04845; G09G 5/30; G06F 3/0482
USPC 715/810; 345/428

(57) ABSTRACT

In a mobile terminal, a failsafe method for image output includes (a) determining the resolution that the mobile terminal can support; and (b) outputting the image according to the resolution determined.

### CROSS REFERENCE TO RELATED APPLICATIONS

The present application is related to and claims priority of Chinese patent application, serial no. 201310240094.5, filed on Jun. 17, 2013. The disclosure of the Chinese patent application is hereby incorporated by reference in its entirety.

### BACKGROUND OF THE INVENTION

1. Field of the Invention

The present invention relates to image processing. In particular, the present invention relates to an image output method for a mobile terminal.

2. Discussion of the Related Art

Users of personal computers (PCs), mobile terminals or cloud servers, and other equipment may save multiple images on such devices. Such images are often used as desktop “wall papers” or slides, to be sent to others or to be uploaded to a server for sharing over a computer network. As a result, various image processing software has been developed. The image processing software can provide a variety of image editing features, such as picture combination, zooming, rotation, adding a frame, text, and decorations to the picture. For example, multiple pictures may be combined to form a composite image. Combining multiple pictures may enrich content and visual effects. Furthermore, in picture sharing, a user's sending or uploading a composite image achieves the same effect as sending or uploading multiple images.

After a user finishes editing a picture using image processing software, two ways are available for outputting the edited picture. First, the user may want to store the edited picture locally. In addition, the user may send the picture to other users, or upload the picture to a website over the network to facilitate sharing. For example, pictures may be uploaded to to the Qzone, WeChat, Twitter, Facebook, or any other social networking website or service.

In the prior art, images are output by image processing software at a default resolution. If the default resolution exceeds the range of resolutions currently supported by the mobile device, a user will not be able to save the edited picture locally (i.e., within the storage on the mobile terminal), thus frustrating the user.

### SUMMARY

According to one embodiment of the present invention, a method and an apparatus are proposed for image output from a mobile terminal with a reduced image output failure rate. The present invention may be realized in a mobile terminal, in an application program, and a storage medium. In one embodiment, the method includes the steps of (a) determining the range of resolutions supported by the mobile terminal; and (b) outputting an image at a resolution within the range of resolutions supported by the mobile terminal. The image may be output to a storage device on the mobile terminal, or be transmitted or uploaded to a user specified network address. Furthermore, before the image is output, the method may further include the steps of (c) displaying a list of resolutions that are within the range of supported resolutions; and (d) receiving the user's selection of a resolution from the displayed list. Under this method, the image is output at the resolution selected by the user.

According to one embodiment of the present invention, prior to determining the range of the supported resolutions, the method may further include (e) providing a selectable button for a user to initiate a test for the range of resolutions supported; and (f) upon detecting the user's selection of the button, performing the step of determining the range of resolutions supported by the mobile terminal.

According to one embodiment of the present invention, the method may further include, prior to image output, providing an image editing interface that displays the image or images to be output. The image editing interface may also include a selectable button for a user to provide an image output command. Under that embodiment, upon receiving through the button the user's image output command, the range of resolutions supported by the mobile terminal is determined, and the image is output according to the resolution selected by the user from the displayed list of resolutions.

According to one embodiment of the present invention, the image output may include a composite image formed from two or more images.

According to one embodiment of the present invention, the range of resolutions supported by the mobile terminal may depend on the condition of the mobile terminal hardware, including storage and central processor unit (CPU) utilization rates and one or more parameters that indicate network conditions.

According to one embodiment of the present invention, determining the range of resolutions supported by the mobile terminal includes, for each of a number of predetermined aspect ratios, determining the resolutions supported by the mobile terminal under that aspect ratio.

By avoiding image output failure, user experience is enhanced. Further, when the user selects a resolution from among those resolutions supported by the mobile terminal, high quality in the output image is ensured, thus avoiding user frustration of receiving a fuzzy (i.e., resolution too low) output image. Furthermore, by selecting the appropriate resolution, the user may control bandwidth usage, as bandwidth usage depends upon the size of the output image, which depends on the resolution selected.

The present invention may be incorporated into an apparatus, which includes resolution determination module that determines a range of resolutions supported by the mobile terminal; and an image output module that output images according to the resolutions determined to be supported by the mobile terminal. The image may be output to a storage device on the mobile terminal, or be transmitted or uploaded to a user specified network address. Furthermore, the apparatus may further include a resolution list display module, for displaying a list of supported resolutions, after the resolution determination module determines the range of supported resolutions; and a user selection receiving module, for receiving the user's selection of a resolution from the displayed list, so that the image output is determined by the resolution selected by the user.

According to one embodiment of the present invention, prior to determining the range of the supported resolutions, the resolution determination module may further provide a selectable button for a user to initiate a test for the range of resolutions supported; and upon detecting the user's selects the button, the resolution determination module determines the range of resolutions supported by the mobile terminal.

According to one embodiment of the present invention, the apparatus may further include an image editing interface module which, prior to image output, provides an image editing interface that displays the image or images to be output. The image editing interface may also include a selectable button for a user to provide an image output command. Under that embodiment, upon receiving through the button the user's image output command, the range of resolutions supported by the mobile terminal is determined, and the image is output, according to the resolution selected by the user from the displayed list of resolutions.

According to one embodiment of the present invention, the resolution determination module determines the range of resolutions supported by the mobile terminal by: for each of a number of predetermined aspect ratios, determining the resolutions supported by the mobile terminal under that aspect ratio.

The present invention may be incorporated into a mobile terminal, which includes: housing, a display screen, a processor, a memory, and a circuit board. In that embodiment, the display screen is mounted on the housing and the circuit board is enclosed in the interior of the housing. Both the processor and the memory are mounted on the circuit board, with the memory storing executable program code executable by the processor to carry out any of the methods of the present invention or to embody any of the apparatuses of the present invention.

The present invention may also be incorporated into an application program or incorporated into a non-transitory storage medium. Both the application program and the non-transitory storage medium incorporate executable program code for carrying out any of the methods of the present invention or which embodies any of the apparatuses of the present invention.

The present invention is better understood upon consideration of the detailed description below and the accompanying drawings.

### BRIEF DESCRIPTION OF THE DRAWINGS

FIG. 1 shows flow chart 100 of a method for image output carried out in a mobile terminal, according to one embodiment of the present invention.

FIG. 2 shows flow chart 200 of a method for image output carried out in a mobile terminal, according to one embodiment of the present invention.

FIG. 3 shows flow chart 300 of a method for image output carried out in a mobile terminal, according to one embodiment of the present invention.

FIG. 4(a) shows flow chart 400 of a method for image output carried out in a mobile terminal, according to one embodiment of the present invention.

FIGS. 4(b) and 4(c) show images of image editing interface 450, in accordance with a method of FIG. 4(a) in accordance with one embodiment of the present invention.

FIG. 5 shows block diagram 500 of an apparatus incorporated in a mobile terminal, according to one embodiment of the present invention.

FIG. 6 shows block diagram 600 of an apparatus incorporated in a mobile terminal, according to one embodiment of the present invention.

FIG. 7 shows block diagram 700 of an apparatus incorporated in a mobile terminal, according to one embodiment of the present invention.

FIG. 8 shows block diagram 800 of a mobile terminal, according to one embodiment of the present invention.

### DETAILED DESCRIPTION OF THE PREFERRED EMBODIMENTS

In the detailed description provided herein, the same or similar reference numerals denote the same or similar elements or features in specific embodiments having the same or similar components. This detailed description and its accompanying drawings are illustrative of the specific embodiments provided and should not be construed as limiting the present invention. Many modifications and variations within the scope of the present invention are possible. The present invention is set forth in the appended claims.

In this detailed description, unless expressly provided, the terms “first”, “second” and the like are provided for convenience of reference and should not be construed as conveying relative importance. Similarly, unless expressly provided, the terms “connected” and “connects” are to be broadly construed, for example, to cover a fixed connection, a detachably attached connection, or an integral connection. Such a connection may be mechanically connected or electrically connected. Such a connection may refer to a direct connection, or an indirectly connection achieved through one or more intermediary elements. Furthermore, unless otherwise specified, the term “multiple” means two or more.

In this detailed description, a step in a process or method is understood to not be limited by the specifically described implements or means for carrying out that step. In addition, where a process or method is described as being implementable by instructions in an executable code module, segment, or portion, the instructions may be carried out in any order, including simultaneously or in a reversed order than what is described herein. The means and steps described herein may be used within the scope of the present invention in any combination, or individually.

Embodiments of the present invention may be incorporated in any mobile terminal, including a mobile terminal running on the IOS operating system provided by Apple, Inc., the Android operating system or any of the Linux-based operating systems, or the Windows Phone operating system provided by Microsoft Corporation. Of course, the present invention is also applicable to personal computers and other smart mobile devices. The term “mobile terminal” refers, without limitation, to mobile telephones, tablet computers, personal digital assistants, notebook computers and other similar hardware devices.

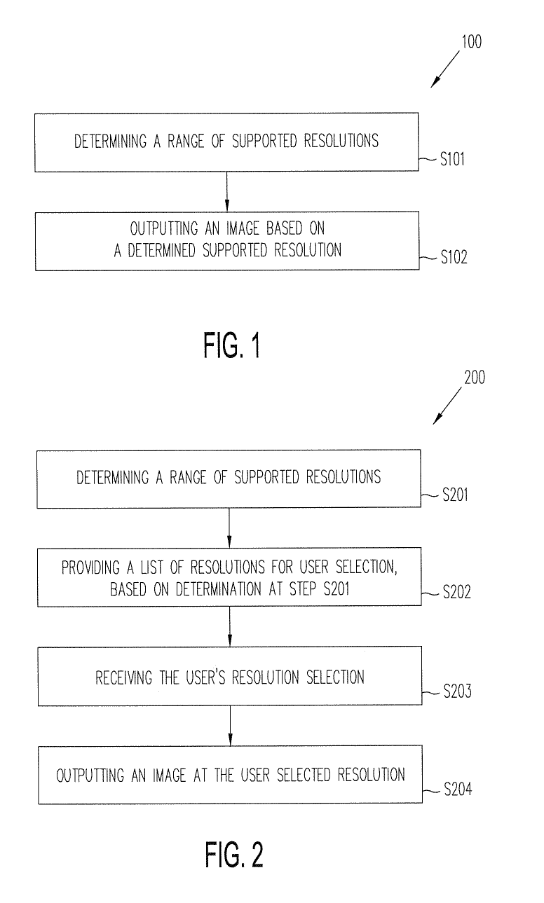

According to one embodiment of the present invention, an image output method is provided in a mobile terminal, as illustrated by flow chart 100 of FIG. 1. The image output method includes (a) step S101, which determines a range of resolutions that the mobile terminal can support; and (b) step S102, which output an image based on one of the resolutions supported by the mobile terminal. In one embodiment, the resolutions supported may vary with the operating state of the mobile terminal, which is affected by memory usage and central processing unit (CPU) utilization rates, network availability or other applicable resource conditions. In that embodiment, some resolutions may not be available for insufficient memory resources, as when some of the mobile terminal's memory resources have been dedicated to a game application program. In addition, network availability consideration, for example, may also affect resolutions supported. For example, when the mobile terminal has WiFi connectivity, a higher resolution may be available for output than when the mobile terminal is merely connected to a 3G mobile network.

By first determining the range of resolutions available, a method of the present invention avoids an image output failure due to selection of a resolution that is not currently supported, thereby enhancing the user experience. Image output step S102 may be carried out after image processing or editing, e.g., editing a composite image formed by combining multiple images. The image output may also be achieved, for example, using an image input device (e.g., a camera). Alternatively, the image may also be downloaded from a computer network, or through any other suitable means by which images may be obtained.

The image output options in step S102 may include, for example, storing images locally in the mobile terminal, or transmitting or uploading the image to an address specified by the user. In that regard, an image may be sent to another device, or uploaded to a server, such as those in Qzone, WeChat or Twitter, a social media service (e.g., Facebook), or any other suitable image holding resource.

Alternatively, according to one embodiment of the present invention, in step S101, the resolutions that can be supported by the mobile terminal may be determined from the state of the mobile terminal hardware. The state of the mobile terminal hardware includes one or more of the utilization rate of the internal storage, the utilization rate of the central processing unit (CPU), and network condition information. For example, when the mobile terminal has a low utilization rate in its internal storage, while the network conditions favor mass data transfer (e.g., the mobile terminal has access to a WiFi (i.e., wireless fidelity, wireless compatibility verified) network, the mobile terminal can support a higher resolution. When the mobile terminal has a high internal storage utilization rate, or when the CPU has a high utilization rate, the mobile terminal will have a lower resolution. For example, when the mobile terminal is being used for a game application program, the resolution is lower. Therefore, by determining a resolution for image output based on hardware conditions, a mobile terminal is able effectively reduce the instances of image output failure, increase the number of successful image output, thereby enhancing user experience.

Alternatively, according to another embodiment of the present invention, in Step S101, the resolution that can be supported by the mobile terminal may be determined from the state of the hardware and the image to be output. For example, assuming each image to be output is a composite image formed by two or more component images, and assuming that the composite images may have different layouts, the range of resolutions that may be supported by the mobile terminal for output of that composite image may be affected, for example, by the sizes, shapes or locations of the component images, the number of such component images, or arrangement of the component images in each composite image. Therefore, in step S101, the resolution that can be supported by the mobile terminal for a given image may be determined by the state of the hardware and information regarding the component images in the image (e.g., layout of the component images).

In one embodiment of the present invention, determining the resolutions supported by the mobile terminal (e.g., step S101 of FIG. 1) may include determining the resolutions supported for each image aspect ratio under the current operating conditions of the mobile terminal. Under each common aspect ratio (e.g., 1:1, 3:4 and 16:9) may be provided a number of different resolutions (e.g., 1920 p to 270 p, where p is a pixel unit). The resolutions under each aspect ratio may be tested sequentially. Further, not every resolution needs to be tested. If any resolution is not supported, testing of all other resolutions requiring greater system resources need not be carried out. By actually testing the possible resolutions at the time of image output under actual operating conditions, the chance of an output failure is greatly diminished.

It is to be understood that, the embodiments of the present invention disclosed herein do not limit the means or methods by which the mobile terminal determines the supportable resolution. For example, a person of ordinary skill in the art may use publically known knowledge or techniques to determine the manner in which a supportable resolution of a mobile terminal can be determined.

FIG. 2 shows flow chart 200 of a method for image output carried out in a mobile terminal, according to one embodiment of the present invention. In the embodiment of FIG. 2, the mobile terminal receives a user's selection of an output resolution from a list displaying a range of resolutions supported by the mobile terminal. Specifically, as shown in FIG. 2, the method of flow chart 200 in FIG. 2 includes (a) at step S201, determining a list of resolutions that are supported; (b) at step S202, displaying a list of resolutions for user selection (e.g., providing a resolution selection menu) based on the resolutions determined at step S201 to be supported, the list need not present all supported resolutions; (c) at step S203, receiving from the user a selection of resolution in the list; and (d) at step S204, outputting an image based on the user's selected resolution. Note that, the resolution selection menu may display resolution options in different ways and forms. For example, the resolution selection menu may display the available resolutions in low to high or high to low order.

In addition to avoiding output failure, the method of FIG. 2 enables the user to have a more direct understanding of the resolutions that the mobile terminal can support. By allowing the user to select the output resolution, this method avoids outputting an image that the user may discover at a later time to be too low in resolution to meet his or her needs. Further, the user may also selects a resolution based on an appropriate size desired by the user, thereby preventing waste of bandwidth in outputting an unnecessarily large image.

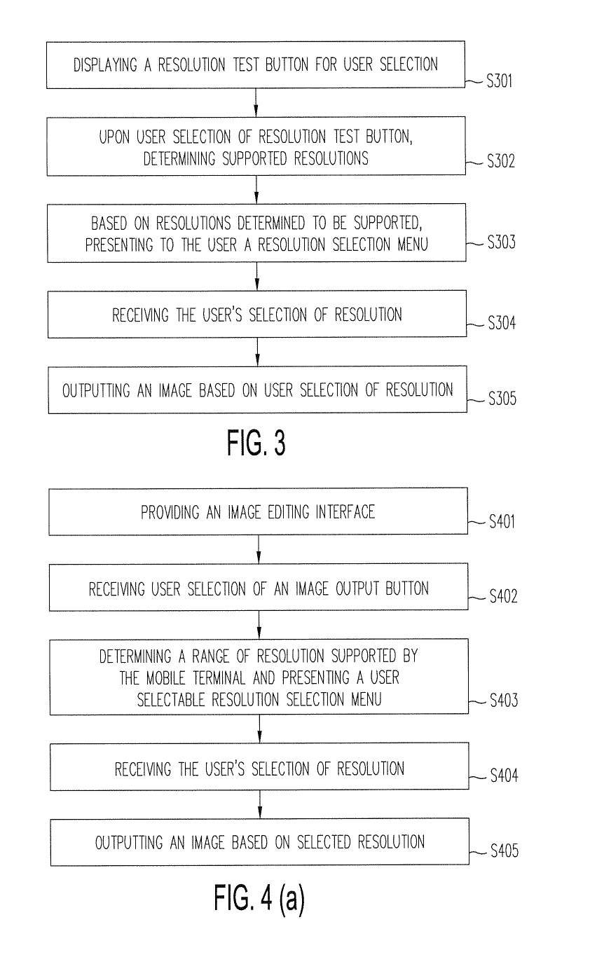

FIG. 3 shows flow chart 300 of a method for image output carried out in a mobile terminal, according to one embodiment of the present invention. In flow chart 300, the user is provided a resolution test button to initiate determining the supported resolutions. When the resolution button is selected by the user, the mobile terminal determines the range of resolutions that the mobile terminal supports under the operating conditions at the time the resolution test button is selected. Specifically, as shown in FIG. 3, at step S301, the mobile terminal displays a resolution test button for user selection. The resolution test button may be displayed at any suitable size, location, style or shape. For example, such a resolution test button may be provided, along with an image output button, in an image editing interface of an image editing software application. As discussed above, image output may include, for example, saving an image in local or remote storage, or uploading the image for sharing with others on a social media website. Alternatively, according to another embodiment of the present invention, the resolution test is implicitly included in the image output button, such that the user's selection automatically initiates, prior to actual output, a test to determine the resolutions supported by the mobile terminal. The image editing software's settings menu or the system settings menu may allow the user to configure whether or not the resolution test button is expressly provided (i.e., as a button separate from the image output button).

At step S302, upon receiving the user's selection of the resolution test button, the mobile terminal can determines a range of resolutions that are supported under the operating conditions of the mobile terminal at the time of user selection. At step S303, based on the resolutions determined to be supported, presenting to the user a resolution selection menu from which the user may select a resolution for image output. As discussed above, the resolution selection menu need not present all supported resolutions. At step S304, the mobile terminal receives the user's selection of resolution. At step S305, outputting an image at the user selected resolution.

Prior to step S305, the method of this embodiment may also include providing an image editing interface which displays the image that is to be output. This step of providing an image editing interface may also be provided prior to or simultaneously with step S302 (i.e., determining a range of supported resolutions). The output image may be a single image or a composite image formed by two or more component images. These images may be retrieved locally from local storage (e.g., a Secure Digital (SD) memory card), an image input device (e.g., a camera), or image discovering software. Alternatively, the images may also be retrieved from a cloud server, or a social media site on a computer network where users share images.

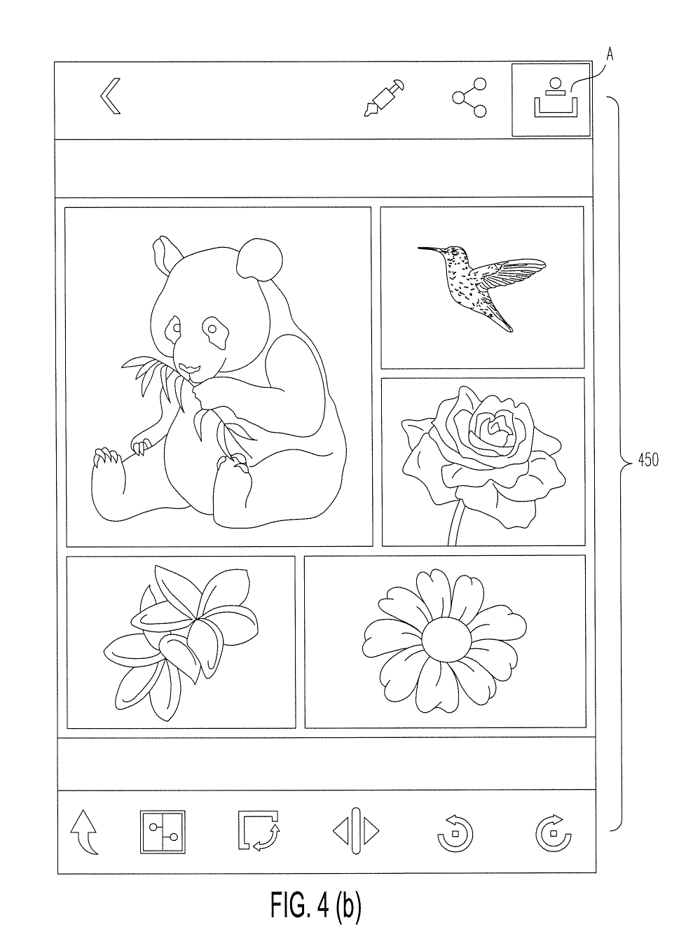

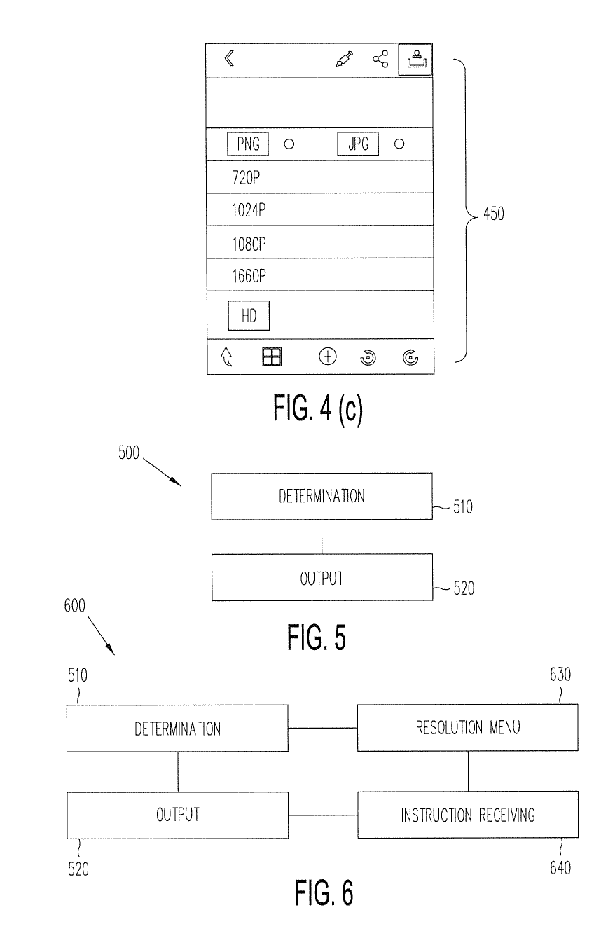

FIG. 4(a) shows flow chart 400 of a method for image output carried out in a mobile terminal, according to one embodiment of the present invention. The method of flow chart 400 may be carried out, for example, in conjunction with image processing or editing software. The method of flow chart 400 may be described with reference to FIGS. 4(b) and 4(c), which show images of image editing interface 450, in accordance with a method of flow chart 400 in FIG. 4(a) in one embodiment of the present invention. At step S401, the mobile terminal provides an image editing interface, which displays an image that may be output, which may be a single image or a composite image formed by two or more images. The image editing interface may also provide an image output button, which allows the edited image to be stored locally or remotely, or to be uploaded to a suitable remote website for various applications. As shown in FIG. 4(b), image editing interface 450 displays a composite image formed from five images, together with exemplary image output button A and various image editing function keys. Of course, other forms of image output button suitable for use in conjunction with any methods described herein are within the scope of the present invention. Image editing interface 450 shown in FIGS. 4(b) and 4(c) are also merely exemplary. The various image editing function keys, for example, may be any number and may have any of a variety of shapes, sizes or designs, as desired.

At step S402, when the user selects image output button A from image editing interface 450, the mobile terminal determines a range of resolutions that can be supported by the mobile terminal. At step S403, based on the resolutions determined to be supported by the mobile terminal in step S402, a resolution selection menu is presented to the user for selection. FIG. 4(c) shows an image of such a resolution selection menu, providing four supported resolutions from which the user may select. At step S404, the mobile terminal receives a user's selection of output resolution in the menu. At step S405, the mobile terminal outputs the image based on the user selected resolution.

One variation to the method of flow chart 400 includes providing a resolution test button in the manner described above with respect to FIG. 3. When a user selects the resolution test button, the supported resolutions of the mobile terminal are determined automatically, which can then be presented for user selection when the user selects the image output button. User selection of output resolution may be presented before or after the user's editing of the image to be output in the image editing interface. Of course, if the user has selected an output resolution prior to editing the image, no resolution selection menu need be presented at the time the user selects the image output button.

The present invention also provides an apparatus for image output. FIG. 5 shows block diagram 500 of an apparatus incorporated in a mobile terminal, according to one embodiment of the present invention. As shown in FIG. 5, the apparatus includes resolution determination module 510 and image output module 520. Resolution determination module 510 determines the range of resolutions supported by the mobile terminal under the operating conditions at the time of determination. Image output module 520 performs image output based on a supported resolution according to one of the supported resolutions. This apparatus may incorporate, for example, the method of flow chart 100 of FIG. 1. As described above, such a method effectively reduces image output failure, thereby enhancing user experience.

Image output module 520 may be provided in conjunction of image editing or processing software that handles single images or composite images. The image output by image output module 520 may also be obtained by an image input device, such as a camera, may be downloaded over a computer network or may be acquired through any suitable means. In one embodiment, image output module 520 is configured to save an image locally in the mobile terminal or remotely (e.g., transmitted or uploaded to a user specified address). Resolution determination module 510 is configured to determine the supported resolution based on the hardware state or condition at the time of determination, which includes, memory usage and central processing unit (CPU) utilization rates, network availability or other applicable resource conditions. In that embodiment, some resolutions may not be available for insufficient memory resources, as when some of the mobile terminal's memory resources have been dedicated to a game application program. In addition, network availability consideration, for example, may also affect resolutions supported. For example, when the mobile terminal has WiFi connectivity, a higher resolution may be available for output than when the mobile terminal is merely connected to a 3G mobile network.

Resolution determination module 510 avoids an image output failure due to selection of a resolution that is not currently supported, thereby enhancing the user experience. Image output module 520 may be used in conjunction with image processing or editing of a composite image formed by combining multiple images. Image output module 520 may perform, for example, storing images locally in the mobile terminal, or transmitting or uploading the image to an address specified by the user. In that regard, an image may be sent to another device, or uploaded to a server, such as those in Qzone, WeChat, Twitter, a social media service (e.g., Facebook), or any other suitable image holding resource.

Furthermore, when the mobile terminal is handling a composite image formed by two or more component images, the range of resolutions that may be supported by the mobile terminal for output of that composite image may be affected, for example, by the sizes, shapes or locations of the component images, the number of such component images, or arrangement of the component images in the composite image. Therefore, in step S101, the resolution that can be supported by the mobile terminal for a given image to be output may be determined by the state of the hardware and information regarding layout of component images of the image.

In one embodiment of the present invention, resolution determination module 510 may determine the resolutions supported for each image aspect ratio under the current operating conditions of the mobile terminal. Under each common aspect ratio (e.g., 1:1, 3:4 and 16:9) may be provided a number of different resolutions (e.g., 1920 p to 270 p, where p is a pixel unit). The resolutions under each aspect ratio may be tested sequentially. Further, not every resolution needs to be tested. If any resolution is not supported, testing of all other resolutions requiring greater system resources need not be carried out. By actually testing the possible resolutions at the time of image output under actual operating conditions, the chance of an output failure is greatly diminished.

FIG. 6 shows block diagram 600 of an apparatus incorporated in a mobile terminal, according to one embodiment of the present invention. As shown in FIG. 6, an apparatus incorporated into a mobile terminal includes resolution determination module 510, image output module 520, resolution menu module 630 and instruction receiving module 640. In this embodiment, resolution determination module 510 and image output module 520 perform similar functions as resolution determination module 510 and image output module 520 discussed above with respect to FIG. 5. Resolution menu module 630 presents a resolution selection menu for user selection after resolution determination module 510 determines the supported resolution. Instruction receiving module 640 for receives the user's selection of a resolution from the presented resolution menu.

Resolution menu module 630 need not present all supported resolutions. The resolution selection menu may display resolution options in different ways and forms. For example, the resolution selection menu may display the available resolutions in low to high or high to low order.

In addition to avoiding output failure, the apparatus of FIG. 6 enables the user to have a more direct understanding of the resolutions that the mobile terminal can support. By allowing the user to select the output resolution, this method avoids outputting an image that the user may discover at a later time to be too low in resolution to meet his or her needs. Further, the user may also selects a resolution based on an appropriate size desired by the user, thereby preventing waste of bandwidth in outputting an unnecessarily large image.

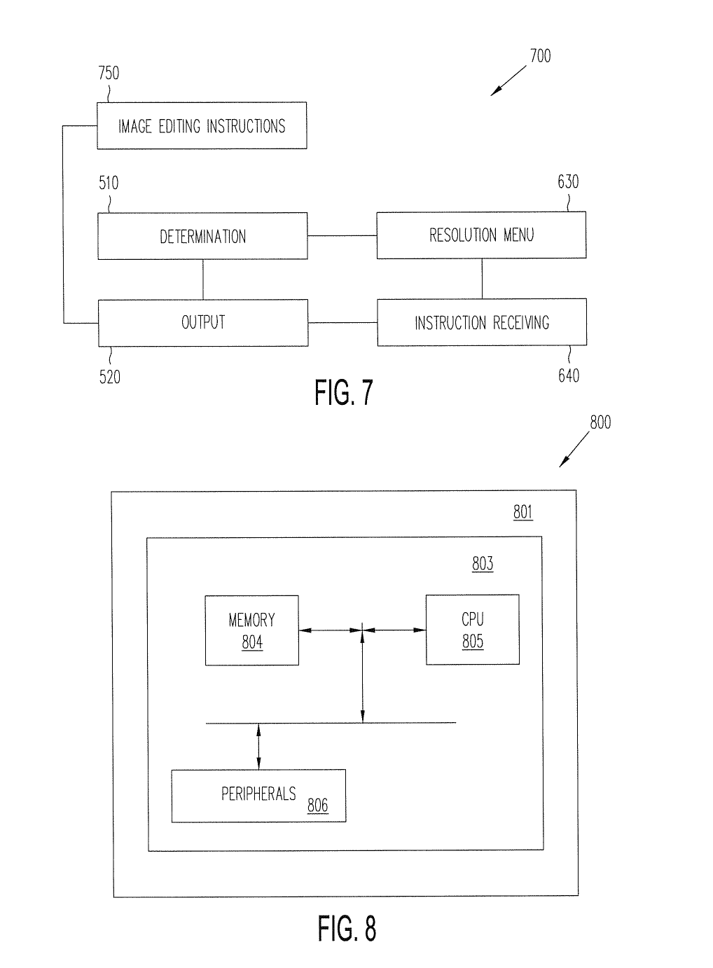

FIG. 7 shows block diagram 700 of an apparatus incorporated in a mobile terminal, according to one embodiment of the present invention. As shown in FIG. 7, the apparatus includes resolution determination module 510, image output module 520, resolution menu module 630, instruction receiving module 640, and image editing interface module 750. Resolution determination module 510, image output module 520, resolution menu module 630, and instruction receiving module 640 may be provided in the manner described above in conjunction with apparatuses 500 and 600 of FIGS. 5 and 6. Image editing interface module 750 displays in an image editing interface (e.g., image editing interface 450 of FIGS. 4(b) and 4(c)) an image that may be output, which may be a single image or a composite image formed by two more images. Image editing interface module 750 may also provide an image output button, which allows the edited image to be stored locally or remotely, or to be uploaded to a suitable remote website for various applications. As shown in FIG. 4(b), image editing interface 450 displays a composite image formed from five images, together with exemplary image output button A and various image editing function keys. Of course, other forms of image output button suitable for use in conjunction with any methods described herein are within the scope of the present invention. Image editing interface 450 shown in FIGS. 4(b) and 4(c) are also merely exemplary. The various image editing function keys, for example, may be any number and may have any of a variety of shapes, sizes or designs, as desired.

When the user selects image output button A from image editing interface 450, image editing interface module 750 causes resolution determination module 510 to determine a range of resolutions that can be supported by the mobile terminal. Based on the resolutions determined to be supported by the mobile terminal, resolution menu module 630 presents a resolution selection menu to the user for selection. As discussed above, FIG. 4(c) shows an image of such a resolution selection menu, providing four supported resolutions from which the user may select. Instruction receiving module 640 then receives a user's selection of output resolution in the menu. Image output module 520 then outputs the image based on the user selected resolution.

Image editing interface may also provide a resolution test button in the manner described above with respect to FIG. 3. When a user selects the resolution test button, the supported resolutions of the mobile terminal are determined automatically by resolution determination module 510, which can then be presented for user selection when the user selects the image output button. User selection of output resolution may be presented before or after the user's editing of the image to be output in the image editing interface. Of course, if the user has selected an output resolution prior to editing the image, no resolution selection menu need be presented at the time the user selects the image output button.

FIG. 8 shows block diagram 800 of a mobile terminal, according to one embodiment of the present invention. As shown in FIG. 8, a mobile terminal includes housing 801, together with processor 805, memory 804 mounted on circuit board 803. The mobile terminal also includes display screen 802, which is typically mounted on the front of housing 801, occupying the space coextensive with one surface of housing 801, and thus therefore not expressly shown in FIG. 8. Circuit board 803, including processor 805 and memory 804, are enclosed by housing 801. Circuit board 803 may also include other devices, such as internal storage controller, display drivers that operate the various hardware devices incorporated into the mobile terminal. These devices are collectively indicated in block diagram 800 as “peripherals 806.” Memory 804 stores at run time executable program code that is executed by processor 805. These executable program code includes program code that is executed to carry out any of the methods of the present invention discussed above with respect to FIGS. 1-4, and may be organized according to any of the apparatuses discussed above with respect to FIGS. 5-7.

The present invention may also be incorporated into a mobile terminal as an application program that includes program code executable to carry out any of the methods of the present invention discussed above with respect to FIGS. 1-4, and such program code may be organized according to any of the apparatuses discussed above with respect to FIGS. 5-7.

The present invention may also be incorporated into non-transitory storage medium which content may be retrieved by a mobile terminal. In that embodiment, the content may include program code that is executable to carry out any of the methods of the present invention discussed above with respect to FIGS. 1-4, and such program code may be organized according to any of the apparatuses discussed above with respect to FIGS. 5-7.

Various parts of the present invention can be implemented in hardware, software, firmware, or a combination thereof. For example, one or more steps in each of the methods or apparatuses of the present invention may be implemented as software or firmware, which may then be stored in the memory and executed by a suitable processor to carry out the intended functions. Alternatively, the methods and apparatuses of the present invention may be implemented in hardware, or any combination of hardware, software or firmware. A hardware implementation may include logic functions carried out by logic gates, discrete logic circuits, application specific integrated circuits (ASICs), or programmable logic circuits, such as field programmable gate arrays (FPGAs).

What is claimed is:

1. In a mobile terminal, an image output method, comprising:
determining a range of supported resolutions for image output; and
outputting an image according to one of the supported resolutions.

2. The method of claim 1, wherein outputting the image includes saving the image to a storage medium in the mobile terminal, or uploading the image to a user-specified address.

3. The method of claim 1, further comprising:
displaying on a user interface a resolution selection menu, the resolution selection menu listing a portion of the supported resolutions to allow a user selection;
receiving a user selection of a supported resolution; and
providing the user selected resolution as the resolution for image output.

4. The method of claim 3, further comprising, prior to the step of determining the range of supported resolutions for image output:
providing in the user interface a resolution test button for user selection; and
when a user selects the resolution test button, carrying out the step of determining the range of resolutions for outputting the image.

5. The method of claim 4, wherein the user interface comprises an image editing interface for editing the image to be output.

6. The method of claim 3, wherein the user interface comprises an image editing interface for editing the image to be output, the method further comprises:
providing user selectable image output button in the image editing interface; and
when the user selects the image output button, carrying out the step of determining the range of resolutions for outputting the image.

7. The method of claim 5, wherein the image to be output comprises a composite image formed by two or more component images.

8. The method of claim 1, wherein the range of supported resolutions are determined based on operating conditions of the mobile terminal at the time of carrying out the determining step.

9. The method of claim 8, wherein the operating conditions comprise one or more of: memory usage, central processing unit usage, and network condition.

10. The method of claim 1, wherein determining a range of supported resolutions comprises determining, for each image aspect ratio, whether or not one or more resolutions are supported.

11. In a mobile terminal, an apparatus for outputting an image, comprising:
a resolution determination module for determining a range of supported resolutions for image output; and
an image output module for outputting an image according to one of the supported resolutions.

12. The apparatus of claim 11, wherein the image output module performs one or more of: saving the image to a storage medium in the mobile terminal, or uploading the image to a user specified address.

13. The apparatus of claim 12, further comprising:
a resolution menu module for displaying on a user interface a resolution selection menu, the resolution selection menu listing a portion of the supported resolutions to allow a user selection; and
an instruction receiving module for receiving a user selection of a supported resolution that is then provided as the resolution for image output by the image output module.

14. The apparatus of claim 13, further comprising an image editing interface module which, prior to the resolution determining module determines the range of supported resolutions for image output, provides in an user interface a resolution test button for user selection; wherein, when a user selects the resolution test button, the resolution determination module determines the range of resolutions for outputting the image.

15. The apparatus of claim 14, wherein the image editing interface module displays the image to be output.

16. The apparatus of claim 13, wherein a user selectable image output button is provided in an image editing interface and wherein, when the user selects the image output button, the resolution determination module determines the range of resolutions for outputting the image.

17. The apparatus of claim 15, wherein the image to be output comprises a composite image formed by two or more component images.

18. A mobile terminal, comprising:
a housing;
a display screen mounted on the housing;
a processor;
a memory storing program code executable by the processor; and
a circuit board enclosed by the housing and on which the processor and the memory are mounted, wherein the program code carries out a method of image output comprising the steps of:
determining a range of supported resolutions for image output; and
outputting an image according to one of the supported resolutions.

19. The mobile terminal of claim 18, wherein outputting the image includes saving the image to a storage medium in the mobile terminal, or uploading the image to a user-specified address.

20. The mobile terminal of claim 18, wherein the method of image output further comprises:
displaying on a user interface a resolution selection menu, the resolution selection menu listing a portion of the supported resolutions to allow a user selection;
receiving a user selection of a supported resolution; and
providing the user selected resolution as the resolution for image output.

21. The mobile terminal of claim 20, wherein the method for image output further comprises, prior to the step of determining the range of supported resolutions for image output:
providing in the user interface a resolution test button for user selection; and
when a user selects the resolution test button, carrying out the step of determining the range of resolutions for outputting the image.

22. The mobile terminal of claim 21, wherein the user interface comprises an image editing interface for editing the image to be output.

23. The mobile terminal of claim 20, wherein the user interface comprises an image editing interface for editing the image to be output, the method for image output further comprises:
providing user selectable image output button in the image editing interface; and
when the user selects the image output button, carrying out the step of determining the range of resolutions for outputting the image.

24. The mobile terminal of claim 22, wherein the image to be output comprises a composite image formed by two or more component images.

25. A non-transitory storage medium containing executable program code for execution on a computer, wherein the program code carries out an image output method, comprising:
determining a range of supported resolutions for image output; and
outputting an image according to one of the supported resolutions.
